(19) United States
(12) Patent Application Publication
(10) Pub. No.: US 2026/0241799 A1
(43) Pub. Date: Aug. 20, 2026

(54) ENERGY MANAGEMENT SYSTEM FOR A VEHICLE

(71) Applicant: Schaeffler Technologies AG & Co. KG, Herzogenaurach (DE)

(72) Inventors: Michael Heilmann, Karlsruhe (DE); Patrick Gramann, Renchen (DE); Jonas Kniel, Karlsruhe (DE); Christoph Benz, Achern (DE)

(73) Assignee: Schaeffler Technologies AG & Co. KG, Herzogenaurach (DE)

(21) Appl. No.: 19/162,658

(22) PCT Filed: Feb. 14, 2024
(86) PCT No.: PCT/DE2024/100122

§ 371 Date: Sep. 5, 2025

(30) Foreign Application Priority Data
Mar. 7, 2023 (DE) 10 2023 105 507.0

(51) Int. Cl. B60L 1/14; B60L 15/00

(52) U.S. Cl. CPC B60L 1/14; B60L 15/007

(57) ABSTRACT

An energy management system for a vehicle, which assigns profiles to a plurality of energy converters, such as electric motors for traction drive or heating systems, receives requests for mechanical energy or thermal energy and selects energy converters on the basis of the respective profile in order to fulfil the requests. The energy management system can additionally define operating parameters for the selected energy converters. The profiles can be adapted to the operating state of the vehicle and to an environment of the vehicle. The profiles can further be adapted by machine learning.

### CROSS-REFERENCE TO RELATED APPLICATIONS

This application is the U.S. National Phase of PCT Appln. No. PCT/DE2024/100122, filed Feb. 14, 2024, which claims the benefit of German Patent Appln. No. 102023105507.0, filed Mar. 7, 2023, the entire disclosures of which are incorporated by reference herein.

### TECHNICAL FIELD

The disclosure relates to an energy management system for the efficient operation of a plurality of energy converters of a vehicle, as well as to a vehicle equipped with such an energy management system.

### BACKGROUND

When operating a vehicle, a plurality of requests that require energy must be met, often simultaneously. For example, the vehicle should travel at a certain speed, while the vehicle cabin should be heated at the same time. It may also be necessary to keep a source of electrical energy for the vehicle, such as a battery or fuel cell, within a temperature range that is optimal for its operation.

In order to reduce energy losses and thus increase the efficiency of the vehicle, the individual components should obviously work as efficiently as possible; for example, an electric motor for the vehicle's traction drive should have the highest possible efficiency. However, the efficiency achievable in this way is still unsatisfactory.

It is known to operate thermal energy management for a vehicle.

WO 2021/052788 A1 discloses a thermal management system for a vehicle having a first coolant circuit for a battery and a second coolant circuit for an electric motor for driving the vehicle. The two coolant circuits can be operated in series or parallel to each other using a multi-way valve.

DE 10 2019 129 555 A1 describes a temperature management system for a vehicle which coordinates the cooling or heating of a battery and the operation of an interior air conditioning system.

DE 10 2020 206 728 A1 relates to thermal management in an electrified vehicle using two cooling circuits, one of which is operatively connected to an electrical energy storage device of the vehicle.

However, these approaches remain limited to the field of thermal energy.

### SUMMARY

The object of the disclosure is therefore to provide an energy management system for a vehicle which enables energy-efficient operation of the vehicle beyond the thermal sector.

This object is achieved by an energy management system as disclosed herein and/or a corresponding vehicle. Further advantageous embodiments are disclosed.

The energy management system according to the disclosure is intended for use in a vehicle which comprises a source of electrical energy and a multitude of energy converters. The energy converters are configured to convert electrical energy from the source of electrical energy into mechanical energy and/or thermal energy, wherein the multitude of energy converters includes at least one electric motor for the vehicle's traction drive.

According to the disclosure, each energy converter of the multitude of energy converters is assigned a profile by the energy management system, which profile indicates the suitability of the respective energy converter for providing mechanical energy and for providing thermal energy. The energy management system is configured to receive requests for mechanical energy and requests for thermal energy, to select one or a plurality of energy converters of the multitude of energy converters based on the requests and the respective profile, and to generate one or a plurality of control signals containing the information required to use the selected energy converter(s) to fulfil the requests.

The limitation to the thermal sector is exceeded by the inclusion of mechanical energy, in particular for the vehicle's traction drive system. The profiles assigned to the energy converters ensure that the energy management system can select the respective energy converters according to their suitability for the request. The profile of an energy converter contains information on the mechanical power that can be provided by the energy converter, the thermal power that can be provided by the energy converter and, if applicable, a relationship between the mechanical power provided and the thermal power provided.

For example, an electric motor can provide a certain amount of mechanical power for the vehicle's traction drive; however, this also generates waste heat, which can be advantageously used for heating purposes. If the vehicle cabin is also to be heated while driving, the request for heat energy for heating and the profile for the electric motor may mean that the waste heat generated by the electric motor is sufficient for heating. It is then not necessary to provide additional energy from the electrical energy source to operate another energy converter; instead, the waste heat from the electric motor can be used. The energy management system can generate control signals which, when the energy management system is installed in the vehicle, adjust valves in a cooling circuit for the electric motor so that the waste heat from the electric motor is provided for heating the vehicle interior. This results in more energy-efficient operation of the vehicle overall. Embodiments are also conceivable in which the electric motor generates additional losses and thus additional waste heat (limited by the current limit) during a driving request through targeted current modulation triggered by control signals from the energy management system, which can be used for heating purposes as explained above.

The energy management system can, for example, be designed as a data processing system that receives requests via an interface, has stored profiles for the individual energy converters, and selects the energy converter(s) based on the requests and profiles according to programmed rules. The control signals can be output via an interface. Depending on the embodiment, further data can be transmitted to the data processing system and further information can be output by the data processing system. Depending on the embodiment, the data processing system can also be designed to receive information from sensors on board the vehicle.

In one embodiment, the energy management system is further configured to determine operating parameters for at least one of the selected energy converters, wherein the one or the plurality of control signals contain information about the determined operating parameters. The operating parameters can, for example, specify what power is being accessed by an energy converter within the maximum possible limits. In the example above, it could be that not all of the waste heat output from the electric motor is needed for heating purposes. The energy management system would then only request the required proportion of waste heat for heating by means of appropriate operating parameters, for example by means of control signals that are suitable for effecting a corresponding valve setting in the cooling circuit of the electric motor. Conversely, if the waste heat from the electric motor is not sufficient to heat the interior, it can still be used for this purpose, and the energy management system, through appropriate operating parameters, additionally requests only a portion of the possible heating output of a heating element for the interior. The requests can thus be met more flexibly and in an energy-efficient manner.

In one embodiment, the energy management system is further configured to adapt the profile of at least one energy converter of the multitude of energy converters depending on an operating state of the vehicle and/or an environment of the vehicle. In this embodiment, a more situation-appropriate selection of the energy converters and, if necessary, determination of the operating parameters is possible than without such adaptation. If the operating state is characterized by the fact that the vehicle is driving with a high mechanical power output from at least one electric motor, for example at a relatively high speed, a correspondingly high amount of waste heat is generated. This increases the suitability of this at least one electric motor to supply thermal energy in comparison to driving at relatively low speeds, which can be expressed in a profile adapted to the operating state. In another example, if a heating element provides part of its maximum power to maintain the vehicle's electrical energy source at a suitable temperature, this heating element can only provide the remaining part of its maximum power for other purposes, such as heating the vehicle cabin. This can also be reflected in a profile for the heating element in question that is adapted to the operating state. Adaptation to the environment can consist in calling up or at least reserving a certain heating output depending on the outside temperature of the vehicle, which is detected, for example, by a sensor on board the vehicle, in order for it to be reliably available, for example, for heating the vehicle cabin. A further adaptation to the environment may consist of an adaptation to road conditions and/or a traffic situation. The required information can be recorded using cameras, radar, lidar, or similar systems. The inclusion of vehicle-to-vehicle communication is also conceivable.

In a further development, the energy management system is further configured to adapt the profile of at least one energy converter of the multitude of energy converters using a machine-based learning process. In this way, the energy converters can be selected in a way that is better adapted to the typical usage situations of a vehicle equipped with the energy management system, without the need for lengthy adjustments by a user. It is particularly advantageous if the energy management system is configured to perform the machine-based learning process separately for a plurality of drivers of the vehicle. This means that each driver has a set of profiles tailored to their needs, which can be created by the driver without any complex settings. It would be sufficient, for example, for the driver to identify themselves in some way to the energy management system. This can also be done indirectly in the vehicle, for example by selecting a set of settings for the driver's seat and mirrors, which is then communicated to the energy management system in the form of driver identification.

In one embodiment, with or without machine learning, the energy management system can provide a plurality of sets of energy converter profiles from which a user can select a set of profiles. A set of profiles contains a profile for each energy converter to be managed by the energy management system. This means that even the same driver can choose between different profile sets, each adapted to the driving conditions they expect. To follow up on the above examples: If the driver intends to cover a longer distance on the highway, for example, in a ‘highway’ profile set, the electric motors intended for traction drive could be more suitable for providing heat output than a ‘city traffic’ profile set, as motorways are generally driven at higher speeds than in a city, which implies a correspondingly higher mechanical power output from the electric motors, which is associated with higher waste heat.

In a general embodiment, the requests comprise predicted requests. These are requests that do not have to be met immediately, but in the future, within the next five or ten minutes, for example. Longer-term predictions are also conceivable. For example, the charge level of the electrical energy source and the distance to the next charging station on the planned route known from a navigation system could indicate the need to save energy. If necessary, and in particular if authorized by the user, the energy management system could prioritize the request to ‘reach the next charging station’, which is a request to provide mechanical energy for the drive until the charging station is reached, and accordingly save energy in the vehicle cabin, for example by reducing the temperature in the vehicle cabin.

More generally, the requests transmitted to the energy management system can be prioritized, or be prioritized by the energy management system. In both cases, the prioritization can be influenced by driver inputs in certain embodiments. Prioritization can, for example, specify that certain requests should be fully met, even if this means that other requests with lower priority are only partially met or sometimes not met at all.

As already mentioned, the energy converters that can be controlled by the energy management system may comprise an electric motor for the vehicle's traction drive, as well as a system for heating a section of the vehicle. For example, it may be a system for heating the vehicle cabin or a system for maintaining the temperature of the vehicle's electrical energy source (e.g., battery or fuel cell) within a range particularly suitable for its operation. Heating systems that can be used include, but are not limited to, heat pumps or heating resistors such as PTCs. The energy converters controlled by the energy management system may also comprise two or more electric motors for the vehicle's traction drive. For example, one electric motor can drive the front axle of the vehicle and another electric motor can be used to drive the rear axle. A separate electric motor can also be provided for each wheel of the vehicle. Having a plurality of electric motors provides increased flexibility to fulfil requests about vehicle driving, which means increased potential for overall energy-efficient vehicle operation.

A vehicle according to the disclosure comprises a source of electrical energy and a multitude of energy converters which are configured to convert electrical energy from the source of electrical energy into mechanical energy and/or thermal energy, wherein the multitude of energy converters includes at least one electric motor for the vehicle's traction drive. The vehicle according to the disclosure is equipped with an energy management system according to the disclosure as described above. The energy management system is connected, for example, to sensors in the vehicle, directly or indirectly, for example via data processing systems in the vehicle. The energy management system itself can be implemented as a separate data processing system or as part of the functionality of a data processing system that also performs other tasks in the vehicle. Likewise, the energy management system is connected, directly or indirectly, to the energy converters it is intended to control in order to be able to transmit the control signals generated by the energy management system to the respective energy converters.

Requests that are transmitted to the energy management system via one or a plurality of interfaces can arise from a variety of sources. For example, the driver can press the accelerator pedal and thus ultimately transmit a request for mechanical energy to accelerate the vehicle to the energy management system. If the driver sets a desired cabin temperature for the vehicle using a control element, this results, for example, in a request for an air conditioning system to cool or heat the vehicle cabin.

### BRIEF DESCRIPTION OF THE DRAWINGS

In the following, the disclosure and its advantages are described in more detail with reference to the accompanying drawings.

FIG. 1 schematically shows a vehicle according to the disclosure with an energy management system according to the disclosure;

FIG. 2 schematically shows an energy management system according to the disclosure;

FIG. 3 shows an exemplary function of an energy management system according to the disclosure.

The figures merely represent exemplary embodiments of the disclosure and are therefore not to be construed as limiting the disclosure to the exemplary embodiments shown.

### DETAILED DESCRIPTION

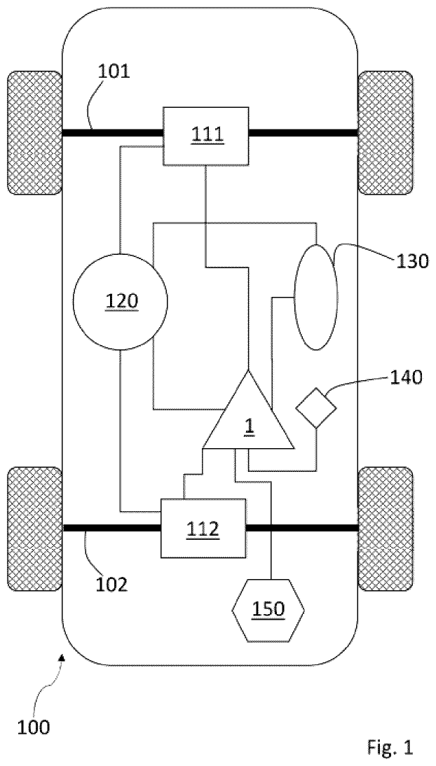

FIG. 1 shows a vehicle 100 according to the disclosure, having two axles 101, 102, each driven by an electric motor 111, 112; the electric motors 111, 112 are energy converters within the meaning of this application and are supplied by a source 120 of electrical energy. The vehicle 100 is equipped with an energy management system 1 according to the disclosure, which in the case shown is designed as a separate data processing unit. The vehicle 100 further comprises one or a plurality of heating systems which may be used, for example, to heat a vehicle cabin or to maintain the source of electrical energy 120 in a temperature range particularly suitable for its operation. A heating system 130 is shown as an example. This could also represent a complete air conditioning system. The heating system 130 is also supplied with electrical energy from the source 120 and is an energy converter within the meaning of the application. A sensor 140 is also shown as an example. The sensor 140, or a plurality of sensors, of which it is representative, can, for example, record information about a temperature in the vehicle 100 or about a temperature in an environment of the vehicle 100. Temperature values recorded in this way can, for example, result in requests for the operation of an air conditioning system or a heating system 130.

The energy management system 1 is connected to the energy converters 111, 112, 130 to send control signals to these energy converters. Requests can be transmitted to the energy management system 1 by the sensor 140 and source of electrical energy 120. In the case of the source 120, these requests may, for example, involve a state of charge of the source 120 or an actual temperature of the source 120, which results in a request to adjust the temperature of the source 120 in order to keep it within a suitable temperature range. Further requests can be transmitted from one or a plurality of user interfaces 150 of the vehicle 100 to the energy management system 1. For example, a driver may wish to accelerate the vehicle 100, which constitutes a request to the energy management system 1 to provide mechanical energy for the traction drive of the vehicle 100 via the electric motor 111 and/or 112. Likewise, a driver could specify a cabin temperature of the vehicle 100 via the user interface 150. This corresponds to a request for the energy management system 1 to provide energy, for example, for the appropriate operation of an air conditioning system. Which energy converters are selected to meet the requests of the energy management system 1 is determined from the profiles of the energy converters stored in the energy management system 1 and the respective requests.

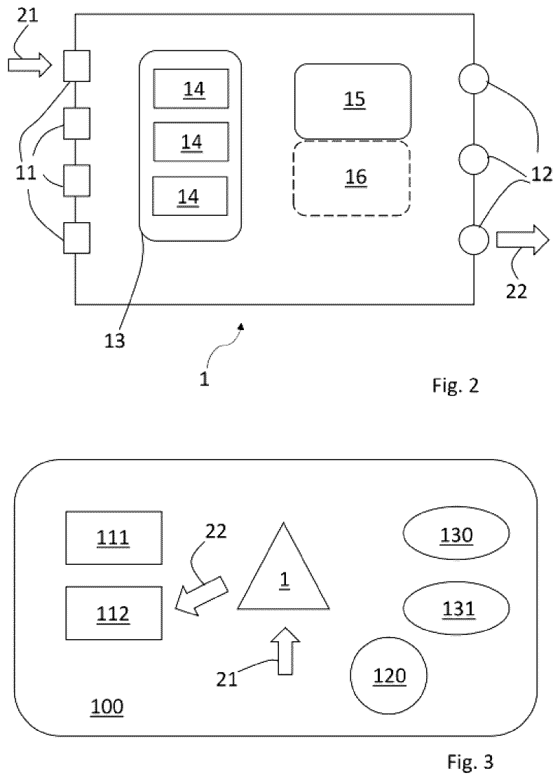

FIG. 2 schematically shows an energy management system 1 according to the disclosure. The energy management system 1 has a multitude of input interfaces 11 to receive requests 21 for mechanical energy and for thermal energy, and a multitude of output interfaces 12 to output control signals 22 to energy converters. Profiles 14 for energy converters to be controlled by the energy management system 1 are stored in a memory 13. A processor 15 processes requests 21 received via the input interfaces 11 and profiles 14 stored in the memory 13 in order to select energy converters to fulfil the requests 21 and to generate corresponding control signals 22 for controlling the selected energy converters, which are then output via the output interfaces 12.

An additional unit 16 can be provided to change the profiles 14 of the energy converters. The changes to the profiles 14 can, for example, consist of adapting the profiles to an operating state of a vehicle. The changes in profiles 14 can also be made by machine learning. The additional unit 16 can be designed as a separate data processing unit or form part of the functionality of the processor 15.

It is further conceivable that the profiles 14 stored in the memory 13 contain a plurality of sets of profiles for the energy converters to be controlled by the energy management system 1; each set of profiles contains a profile 14 for each energy converter to be controlled. For example, a driver can select a set from these sets of profiles 14, or a set of profiles is stored for a plurality of drivers, which is selected after the driver has been identified.

FIG. 3 shows an example to illustrate the function of an energy management system 1 according to the disclosure on board a vehicle 100. The energy management system 1 is provided here to control two electric motors 111, 112 and two heating systems 130, 131. In the example, the energy management system 1 receives a request 21 for 5 KW of heat output. Due to profiles adapted to the operating state, which are stored in the energy management system 1, the following information is available to the energy management system 1: The heating system 130 is in operation to maintain a source of electrical energy 120 at a favorable operating temperature and could only supply an additional 2 kW. The heating system 131 is operating at full load to heat the vehicle cabin and therefore cannot supply any additional energy. The electric motor 111 is used for traction drive and could deliver an additional 1 kW of power. The electric motor 112 is not working and could be operated to provide 5 kW of heat output. Thus, the heating system 131 would not be suitable to meet the request 21, the electric motor 111 and heating system 130 would be suitable to at least partially meet the request 21, and the electric motor 112 is suitable to fully meet the request 21. In the example, the energy management system 1 selects the electric motor 112 according to its programming to fulfil the request 21 and generates a corresponding control signal 22 to the electric motor 112.

### LIST OF REFERENCE SYMBOLS

1 Energy management system
11 Input interface
12 Output interface
13 Memory
14 Profile
15 Processor
16 Additional unit
21 Request
22 Control signal
100 Vehicle
101 Axle
102 Axle
111 Electric motor
112 Electric motor
120 Source of electrical energy
130 Heating system
131 Heating system
140 Sensor
150 User interface

1. An energy management system for a vehicle comprising:
a source of electrical energy;
a multitude of energy converters configured to convert electrical energy from the source of electrical energy into at least one of mechanical energy or thermal energy, wherein the multitude of energy converters includes at least one electric motor for a traction drive of the vehicle;
wherein
each energy converter of the multitude of energy converters is assigned a profile which indicates the suitability of the respective energy converter for providing mechanical energy and for providing thermal energy;
the energy management system is configured to:
receive requests for mechanical energy and requests for thermal energy,
select at least one of the energy converters of the multitude of energy converters based on the requests and the respective profile, and
generate at least one control signal containing information to use the selected at least one energy converter to fulfil the requests.

2. The energy management system according to claim 1, further configured to determine operating parameters for the at least one selected energy converter, wherein the at least one control signal contains information about the determined operating parameters.

3. The energy management system according to claim 1, further configured to adapt the profile of at least one energy converter of the multitude of energy converters depending on at least one of an operating state of the vehicle or an environment of the vehicle.

4. The energy management system according to claim 1, further configured to adapt the profile of at least one energy converter of the multitude of energy converters using a machine-based learning process.

5. The energy management system according to claim 4, wherein the energy management system is configured to perform the machine-based learning process separately for a plurality of drivers of the vehicle.

6. The energy management system according to claim 1, wherein the energy management system provides a plurality of sets of profiles of the energy converters from which a user can select a set of profiles.

7. The energy management system according to claim 1, wherein the requests comprise predicted requests.

8. The energy management system according to one claim 1, wherein the energy converters comprise at least two electric motors for the traction drive of the vehicle.

9. The energy management system according to claim 1, wherein the energy converters comprise at least one system for heating a region of the vehicle.

10. A vehicle comprising:
a source of electrical energy;
a multitude of energy converters configured to convert electrical energy from the source of electrical energy into at least one of mechanical energy or thermal energy, wherein the multitude of energy converters includes at least one electric motor for a traction drive of the vehicle; and
an energy management system for controlling the multitude of energy converters;
wherein each energy converter of the multitude of energy converters is assigned a profile which indicates the suitability of the respective energy converter for providing mechanical energy and for providing thermal energy; and
wherein the energy management system is configured to:
receive requests for mechanical energy and requests for thermal energy,
select at least one of the energy converters of the multitude of energy converters based on the requests and the respective profile, and
to generate at least one control signal containing information to use the selected at least one energy converter to fulfil the requests.

11. The vehicle according to claim 10, wherein the energy management system is further configured to determine operating parameters for the at least one selected energy converter, and wherein the at least one control signal contains information about the determined operating parameters.

12. The vehicle according to claim 10, wherein the energy management system is further configured to adapt the profile of at least one energy converter of the multitude of energy converters depending on at least one of an operating state of the vehicle or an environment of the vehicle.

13. The vehicle according to claim 10, wherein the energy management system is further configured to adapt the profile of at least one energy converter of the multitude of energy converters using a machine-based learning process.

14. The vehicle according to claim 13, wherein the energy management system is configured to perform the machine-based learning process separately for a plurality of drivers of the vehicle.

15. The vehicle according to claim 10, wherein the energy management system provides a plurality of sets of profiles of the energy converters from which a user can select a set of profiles.

16. The vehicle according to claim 10, wherein the requests comprise predicted requests.

17. The vehicle according to claim 10, wherein the energy converters comprise at least two electric motors for the traction drive of the vehicle.

18. The vehicle according to claim 10, wherein the energy converters comprise at least one system for heating a region of the vehicle.
